(19) United States
(12) Patent Application Publication
(10) Pub. No.: US 2014/0172917 A1
(43) Pub. Date: Jun. 19, 2014

(54) PRIVACY AND PERMISSION SYSTEM FOR A SOCIAL NETWORK

(71) Applicant: Trenton Gary Coroy, (US)

(72) Inventors: Trenton Gary Coroy, Steinbach (CA); Timothy Roy Koop, Ste. Anne (CA)

(73) Assignee: Trenton Gary Coroy, Steinbach (CA)

(21) Appl. No.: 14/104,499

(22) Filed: Dec. 12, 2013

Related U.S. Application Data
(60) Provisional application No. 61/737,296, filed on Dec. 14, 2012.

(51) Int. Cl. G06F 21/62

(52) U.S. Cl. CPC G06F 21/6218
USPC 707/783

(57) ABSTRACT

Systems and methods for managing and regulating communications over a social network are disclosed. A first member of the social network may have profile information comprising various information types each having an associated privacy level. A particular information type may be accessed by a recipient if they are assigned a direct permission level satisfying the privacy level of the particular information type. According to one method, the system determines whether a communication has been sent from the first member to the recipient, and automatically assigns the direct permission level to the recipient for accessing the first member's profile information.

### RELATED APPLICATIONS

This application claims priority to U.S. Provisional Application No. 61/737,296, filed on Dec. 14, 2012 and entitled “PRIVACY AND PERMISSION SYSTEM FOR A SOCIAL NETWORK”.

### TECHNICAL FIELD

The present disclosure is directed towards a computer implemented social network, and more particularly, towards a social network having a privacy and permission system for managing and regulating communications over the social network.

### BACKGROUND

A computer implemented social network provides each of its members with the ability to form relationships with other members of the network. Members may contact each other and may also share information with each other through their social network profiles. A profile may include various types of member information, such as the name, address, age, occupation, pictures, and personal interests of the member described by the profile. A profile may also display a list of other members with whom that member has formed relationships. Unfortunately, current social networks fail to provide an effective mechanism for controlling and managing the dissemination of member information and communications between members of the network.

### SUMMARY

According to an aspect, a method for assigning a direct permission level governing access to a first member's profile information on a social network, is disclosed. The method comprises determining whether a communication has been sent from the first member to a recipient, and assigning the direct permission level to the recipient, wherein the profile information comprises a plurality of information types each associated with a privacy level, and a particular information type is accessible by the recipient if the assigned direct permission level satisfies the privacy level of the particular information type.

According to another aspect, a method for granting contact permission to a recipient for contacting a first member through a social network, wherein the recipient is initially prevented from contacting the first member, is disclosed. The method comprises determining whether the first member has sent a communication to the recipient, and when the first member has sent the communication to the recipient, granting contact permission to the recipient to allow the recipient to contact the first member through the social network.

According to another aspect, a method for granting contact permission to a recipient for contacting a first member through a social network, wherein the recipient is initially prevented from contacting the first member, and the first member has profile information on the social network comprising a plurality of information types, is disclosed. The method comprises: accessing a communication from the recipient to the first member, determining an information type from the communication, comparing the information type from the communication to at least one information type from the first member's profile information; and if the information type from the communication substantially matches at least one of the information types from the first member's profile information, granting the contact permission to the recipient.

According to another aspect, a method for viewing a first member's profile information on a social network, wherein the profile information comprises a plurality of information types each associated with a privacy level, is disclosed. The method comprises: receiving a proposed permission level from the first member; for each of the information types, comparing the privacy level for the information type to the proposed permission level; and displaying to the first member the information types with privacy levels satisfied by the proposed permission level.

According to another aspect, a method for reserving a profile for a non-member of a social network, is disclosed. The method comprising accessing a communication from a first member to the non-member, determining a unique identifier for the non-member from the communication, and reserving the profile for the non-member using the determined unique identifier.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 is a block diagram of a social network comprising a privacy and permission system, according to an embodiment.

FIG. 2 shows a profile of a first member according to the embodiment of FIG. 1.

FIG. 3 shows a profile input page for the first member, with privacy level sliders corresponding to each information type, according to the embodiment of FIG. 1.

FIGS. 4(a)-(b) show a contact list display for the first member, according to the embodiment of FIG. 1.

FIGS. 5(a)-(f) show profile viewing pages displaying embodiments of the first member's profile at various permission levels, according to the embodiment of FIG. 1.

### DETAILED DESCRIPTION

Embodiments of the present disclosure are directed towards a system and method for managing and regulating communications over a social network. In particular, the present disclosure is directed, at least in part, at a privacy and permission system that allows a first member of the social network to set privacy levels for different information types that form part of the first member's profile. The first member may also assign different direct permission levels to other members or non-members connected to the social network, which govern the degree to which they may access the different information types of the first member's profile. The disclosed privacy and permission system further comprises a contact permission system that can manage and grant contact permissions to govern communications over the social network.

The social network may be accessed by individuals, entities, or groups, all of whom may be members of the social network having registered accounts (“members”), or non-members who may visit and access the social network without having registered accounts (“non-members”). For example, non-members may comprise individuals, entities or groups who have visited a registered member's profile on the social network, but have not registered an account or created a profile for themselves. Non-members may also comprise individuals, entities or groups who have received a communication from a registered member over the social network, but have not accessed the communication or visited the social network. Non-members may also comprise individuals, entities or groups who have not received a communication from a registered member over the social network, and who have not visited the social network. Through the disclosed privacy and permission system, members of the social network may effectively control, see, and adjust the dissemination of different information types that may be communicated to others (including members and non-members) over the social network. Further, direct permission levels may be assigned on a granular basis, to both members and non-members, to customize the scope and degree to which the first member discloses his or her profile information. The ability to finely and easily control, see, and adjust the flow of profile information increases a member's safety and security, particularly among young social network members.

The present disclosure describes multiple embodiments, and the above introduction is by no means limiting of the disclosed subject matter. Illustrative embodiments are described below.

### Privacy and Permission System Infrastructure

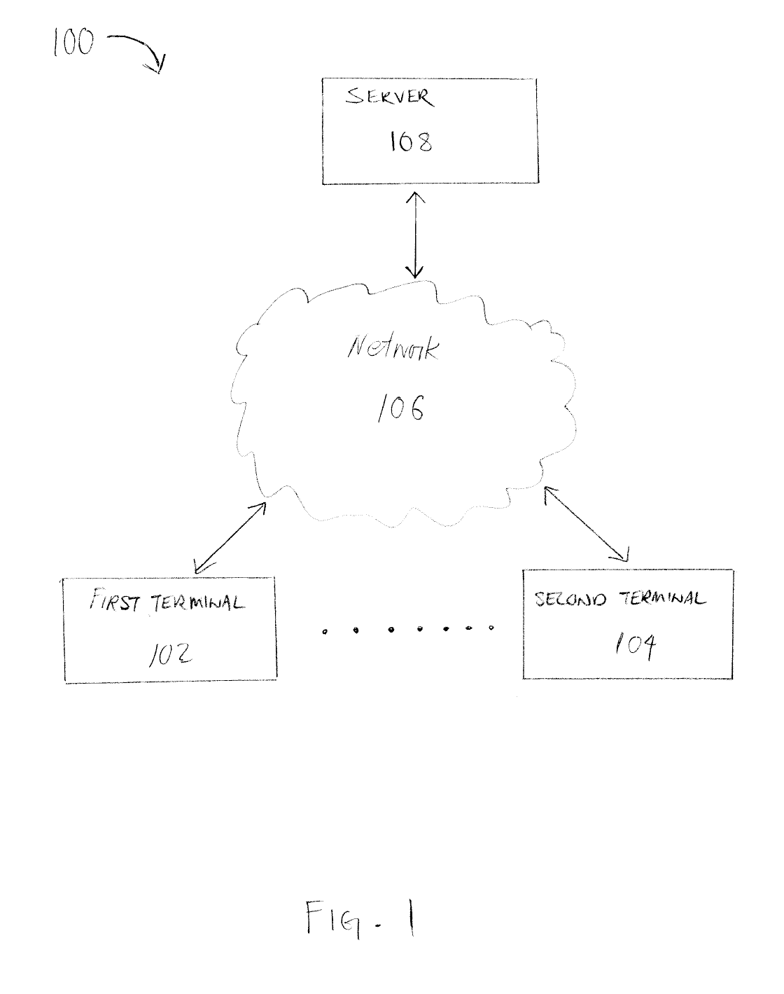

FIG. 1 shows an exemplary embodiment of a social network 100 implementing the disclosed privacy and permission system. The social network 100 includes a first terminal 102 and a second terminal 104 communicatively coupled to a server 108 through a network 106. The first and second terminals 102, 104 may comprise personal computing devices, such as desktop or laptop computers, smart phones, mobile computing devices such as tablets, digital personal assistants, or any type of communications device operable to permit communication between a person and the server 108. The network 106 may comprise a suitable wide or local area network, such as the internet or an intranet. The server 108 may comprise a computer implemented process server capable of establishing communications between the first terminal 102 and the second terminal 104. The disclosed privacy and permission system and the contact permission system may be implemented using a processor (not shown) and a memory (not shown) that form part of the server 108, with the memory having encoded thereon statements and instructions to cause the processor to perform various methods as described below. The disclosed privacy and permission system and the contact permission system may also operate over a computer implemented system carrying out statements and instructions encoded on a computer readable medium for performing the various methods described below. While the server 108 is shown in FIG. 1 as a separate device from the terminals 102, 104, in other embodiments the server 108, or functions of the server 108, may be implemented or performed by one of the terminals 102, 104, or a combination of both terminals 102, 104.

### Profile Display

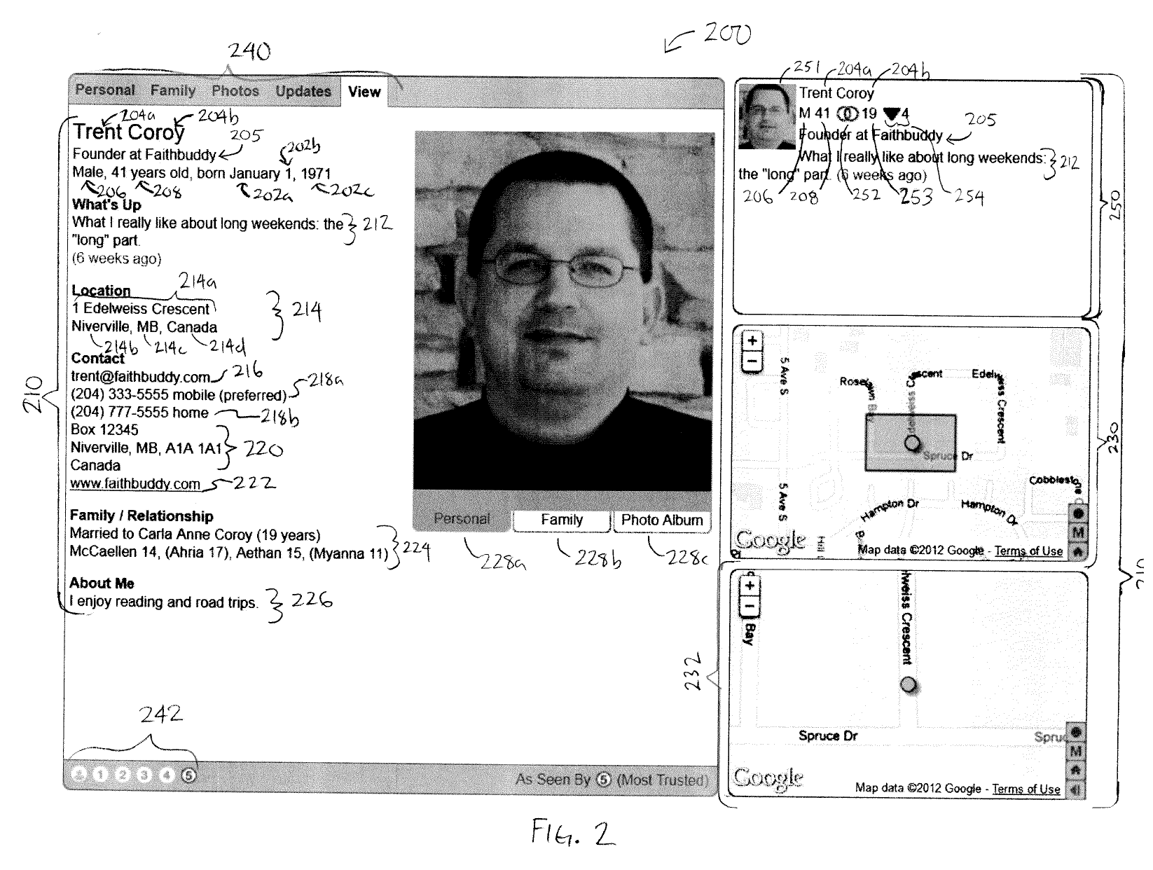

FIG. 2 shows an exemplary embodiment of a first member's profile display 200 (hereinafter, “profile 200”), as displayed to the first member of the social network 100 on one of the terminals 102, 104. In this embodiment, the profile 200 is provided to the first member upon registering an account with the social network. In other embodiments however, profiles may also be provided to non-members of the social network. Although the profile 200 in FIG. 2 is of the first member, profiles for other members or non-members may share similar or identical layouts and formats in other embodiments. Further, the first member's profile 200 may also share a similar or identical layout and format when viewed by others accessing the social network 100. However, certain features of the profile 200, such as the control region 242, may only be provided when the first member views his or her own profile 200.

The profile 200 comprises a plurality of information types 210, each comprising values for different categories of profile information that the first member may wish to share with others who may access the social network 100. For example, the information types 210 may comprise values for the first member's: first name 204a; last name 204b; occupation 205; gender 206; age 208; birth day 202b; birth month 202a; birth year 202c; status or general message 212; physical address/location information 214, including country 214d, province/state 214c, city 214b, and street 214a; email address 216; mobile phone number 218a, home phone number 218b; mailing address 220; and website 222. The information types may also comprise data or values describing the first member's family or relationships 224, miscellaneous information 226, personal photo 228a, family image 228b, and photo album 228c. The information types 210 may also comprise data for one or more map displays 230, 232 depicting different views of the first member's location. In some embodiments, the profile 200 may also provide additional information about the first member, such as the account status of the first member, whether the first member is visible as a registered member of the social network 100, or whether the first member may be contacted by another member or non-member viewing its profile 200.

In some embodiments, the profile 200 may comprise a summary profile 250, which is a summarized profile display comprising a number of information types 210 described above. The information types 210 displayed in the summary profile 250, however, may in some cases be presented in abbreviated or symbolic form. As shown in FIG. 2 for example, the summary profile 250 may comprise values for the first member's: summary personal image 251, first name 204a, last name 204b, gender 206, age 208, relationship status 252 (the example icon shown in FIG. 2 indicating the first member is married), relationship duration 253, number of children 254, occupation 205, and status or general message 212.

In other embodiments (not shown), the information types 210 may further comprise values relating to the first member's family or friends, or to members/non-members who have relationships with the first member. For example, these values may include names or information pertaining to the first member's girlfriend or boyfriend, fiancé or fiancée, spouse, partner, parent, grandparent, great grandparent, uncle, aunt, sibling, cousin, child, grandchild, and/or great grandchild. Examples of information types 210 relating to these persons or others having relationship with the first member include a relationship status, anniversary day and month, anniversary year, significant other first name, significant other last name, number of children, number of grandchildren, number of great grandchildren, number of current foster children, number of former foster children, or other values describing events or aspects between the first member and others. The information types 210 may also comprise others' first name, last name, gender, birth day, birth month, birth year, number of children, whether the person is alive or deceased, death day, death month, death year, and whether the person lives at the same location as the first member or not.

In some embodiments (not shown) the system is able to evaluate the first member's profile information, including one or more relational events, to determine certain information types 210. For example, the system may be able to evaluate relational information including a marriage event and a divorce event between the first member and another member/non-member and determine the first member's relationship status to be “single”. As another example, the system may be able to evaluate relational information including a marriage event between the first member and another member/non-member, and a death date for the same member/non-member and determine the first member's relationship status to be “widowed”. In some embodiments, the first member's profile 200 may comprise a family tree display (not shown) configured to show family relationship information.

The first member can manage and modify the information displayed on his or her profile 200. For example, when accessed by the first member, different pages or folders 240 may be accessible, each of which may allow the first member to input different information types 210, and/or to preview how his or her profile 200 appears to others accessing the social network. As explained in further detail below, the first member may use a control region 242 to see how others would view his or her profile 200 through different assigned permission levels.

### Information Type Input Page and Privacy Level Selection

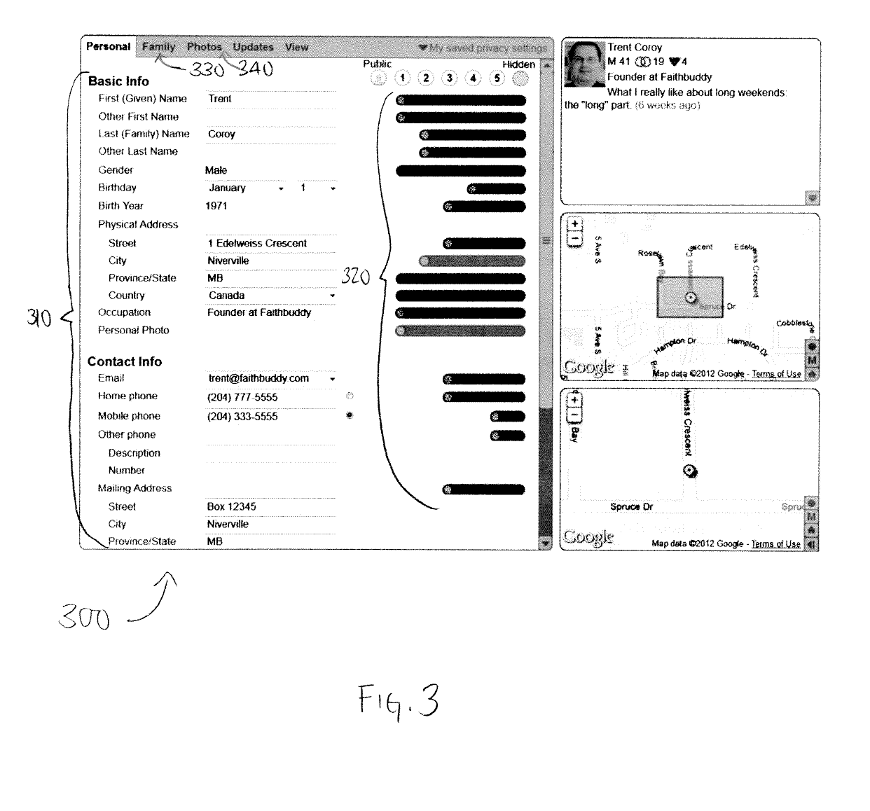

FIG. 3 shows an exemplary profile input page 300 that a first member may access to input information types 210 for his or her profile 200. The profile input page 300 comprises various information type input fields 310 for inputting corresponding information types 210. Privacy level sliders 320 are adjacent to the information type input fields 310 for setting and/or displaying privacy levels to corresponding information types 210. For Example, the privacy level slider beside the input field titled “First (Given) Name” will set and display a privacy level for the information type described as “First (Given) Name”. The privacy level sliders 320 shown in FIG. 3 each comprise one or more of the options, listed in order of increasing privacy, of “public”, “1”, “2”, “3”, “4”, “5”, and “hidden”, but in other embodiments may comprise any suitable range of values. Accordingly, the profile input page 300 allows the first member to input personal information for each information type 210 through corresponding information type input fields 310, and to specify privacy levels for each information type 210 through sliders 320 according to the first member's desired level of privacy for that information type 210. For example, the first member may decide to set certain information types 210 to a non-public privacy level between “1” and “5”, which the system interprets by only allowing other members/non-members who have been assigned a sufficiently high permission level (e.g. a permission level equal to or higher than the privacy level set by the first member) to access such information types 210. As will be explained in further detail below, a permission level may comprise a direct permission level that is assignable from a first member to another member/non-member, a group permission level that is inheritable by a member/non-member for accessing the first member's information types 210, or an effective permission level which may be determined by an inheritance rule. By providing specific privacy levels for each information type 210, the first member can control the display of information types 210 viewable on his or her profile 200 to other members/non-members accessing the social network 100.

In other embodiments, operation and display of the profile input page 300 may also vary in each or all of the following ways:
1. Privacy levels may be determined through other means instead of, or in addition to, being set through privacy level sliders 320.
2. Some privacy levels may not be controllable through their associated privacy level sliders 320, in which case the privacy level sliders 320 merely display the determined privacy levels of corresponding information types 210.
3. Privacy levels for certain information types 210 may be determined according to other information types 210, privacy levels for other information types 210, and/or other information and displayed to the first member through privacy level sliders 320.
4. Privacy level sliders 320 may also be provided for information types 210 relating to others with whom the first member has relationships. In FIG. 3 for example, the family tab 330 may be selected to access a family page or folder comprising information type input fields 310 for information types 210 relating to the first member's family members; the first member may set or view associated privacy levels through corresponding privacy level sliders 320.
5. Information types 210 may be system determined instead of directly entered by a member through information type input fields 310. In such cases, information types 210 may not have a corresponding information type input field 310. In FIG. 3 for example, no information type input fields 310 are provided for the information types 210 corresponding to “Gender” and “Birth Year”. In these examples the information type values “Male” and “1971”, respectively, are displayed instead.
6. Information type input fields 310 and corresponding privacy level sliders 320 may be displayed separately or at different locations. In FIG. 3 for example, the information type 210 for “Personal Photo” may be input through an input field displayed on a “Photos” tab 340 at the top of FIG. 3.

As a further example, and still referring to FIG. 3, the information types 210 corresponding to the information type input fields 310 titled “First (Given) Name”, “Other First Name”, “Occupation”, and “Personal Photo” have all been set to a privacy level of “1”. Accordingly, only other member/non-member recipients that have been assigned a permission level of “1” or greater by the first member will have access to these information types 210 and be able to see them displayed on their terminals when viewing the first member's profile 200; others who have a lower permission level will not be able access and view these information types 210 when viewing the first member's profile 200. As another example, the information types 210 corresponding to “Mobile phone” and “Other phone” have been set to a privacy level of “5” as shown in FIG. 3. Accordingly, only other recipients that have a permission level of “5” will have access to these specific information types 210 and be able to view them on the first member's profile 200; those with a permission level of “4” or lower will not be able to access these information types 210 or see them when viewing the first member's profile 200. Therefore, the first member may selectively set more personal or sensitive information types 210 to a higher privacy level so that they can only be viewed by other member/non-member recipients who have been assigned a higher permission level by the first member. Less sensitive information types 210 may be set to a lower privacy level so that other member/non-member recipients who have been assigned lower permission levels can view them. Therefore, as the first member's relationship, confidence, or trust in another member/non-member progresses, the first member may then assign that member/non-member a higher permission level in order to allow them to view more sensitive or private profile information on his or her profile 200.

Also shown on FIG. 3, the first member's privacy level sliders 320 (and thus privacy levels) may be set to “public” and “hidden”. In the depicted embodiment, a privacy level of “public” for an information type 210 permits all members of the social network 100 to view such information types. In some embodiments information types 210 having a privacy level of “public” may also be accessible and viewable by non-members of the social network 100. A “public” privacy level therefore allows corresponding information types 210 to be displayed freely without having to specifically administer permission levels to others. In contrast, a privacy level of “hidden” hides corresponding information types 210 from all others accessing the social network 100, regardless of any permission level they may have been assigned.

### Contact List Display

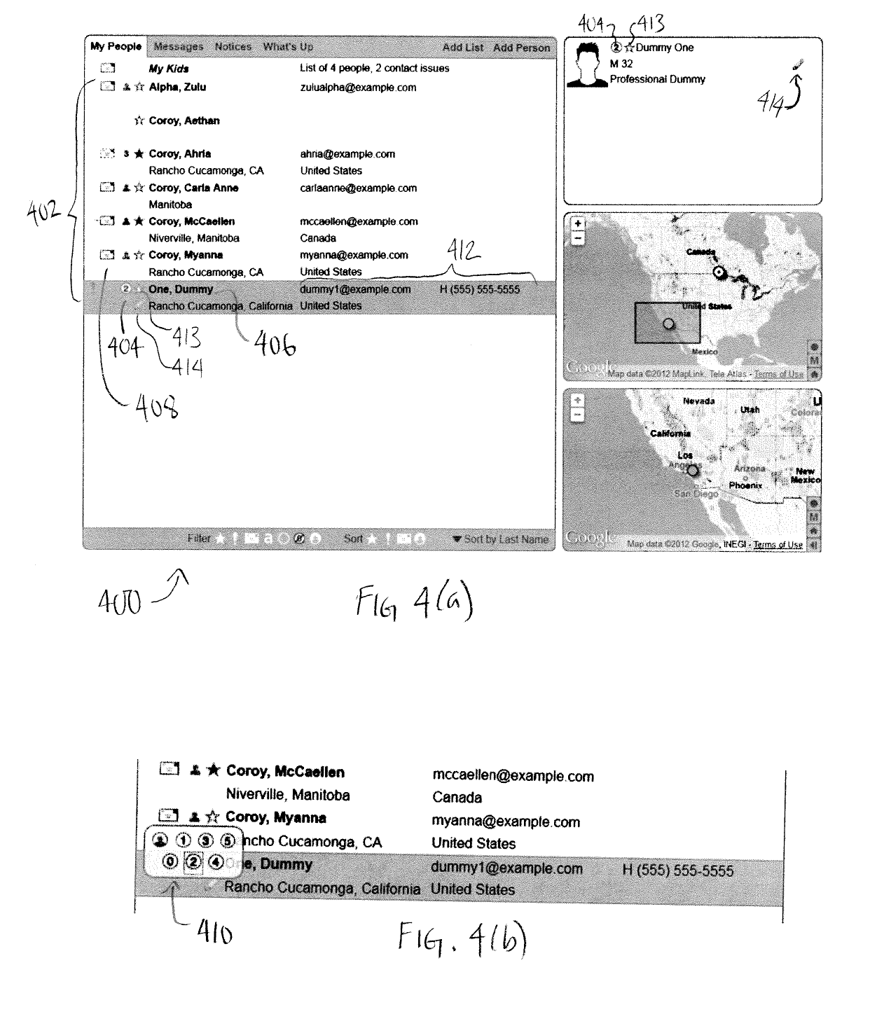

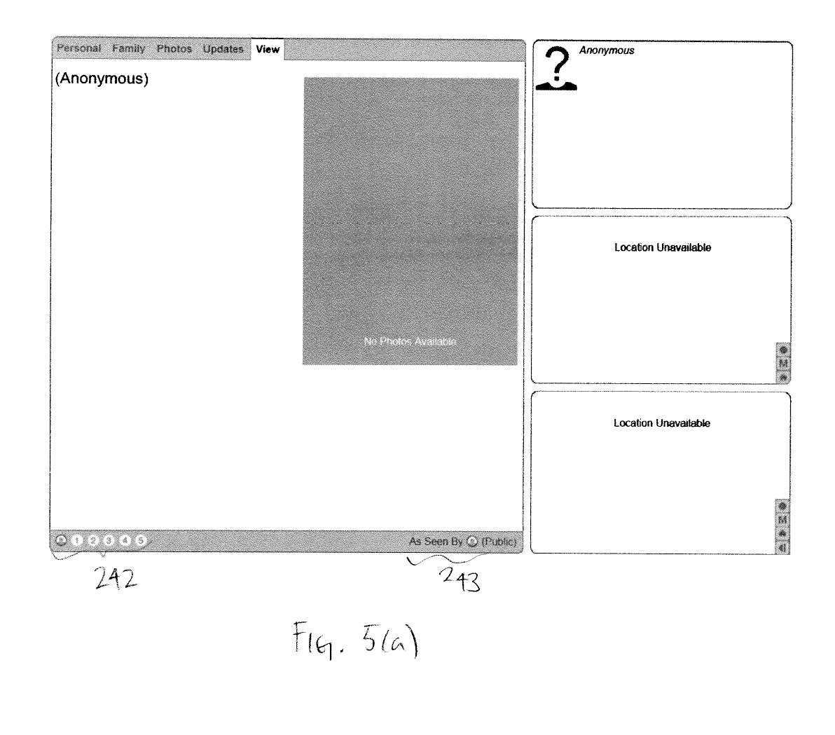

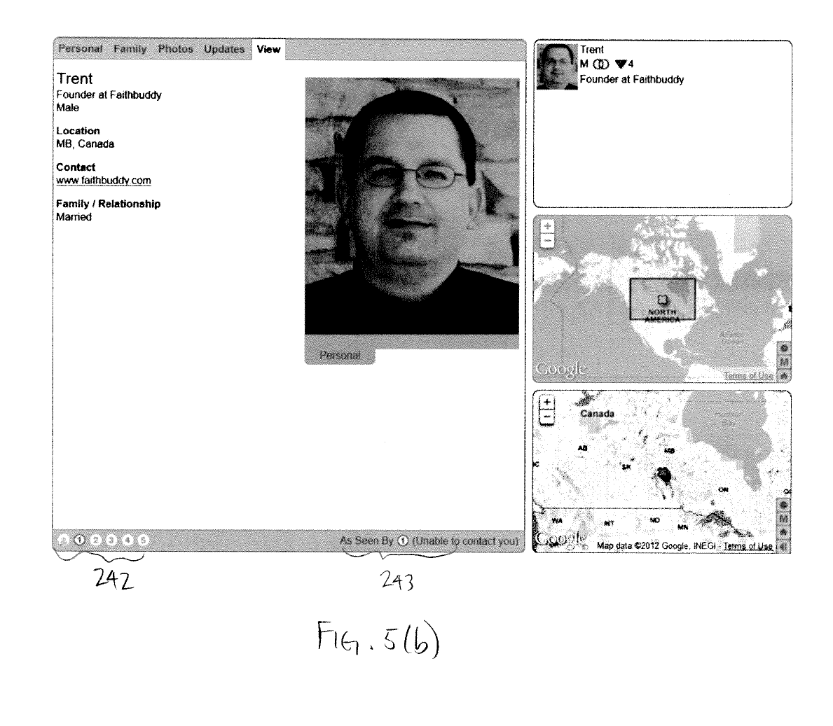

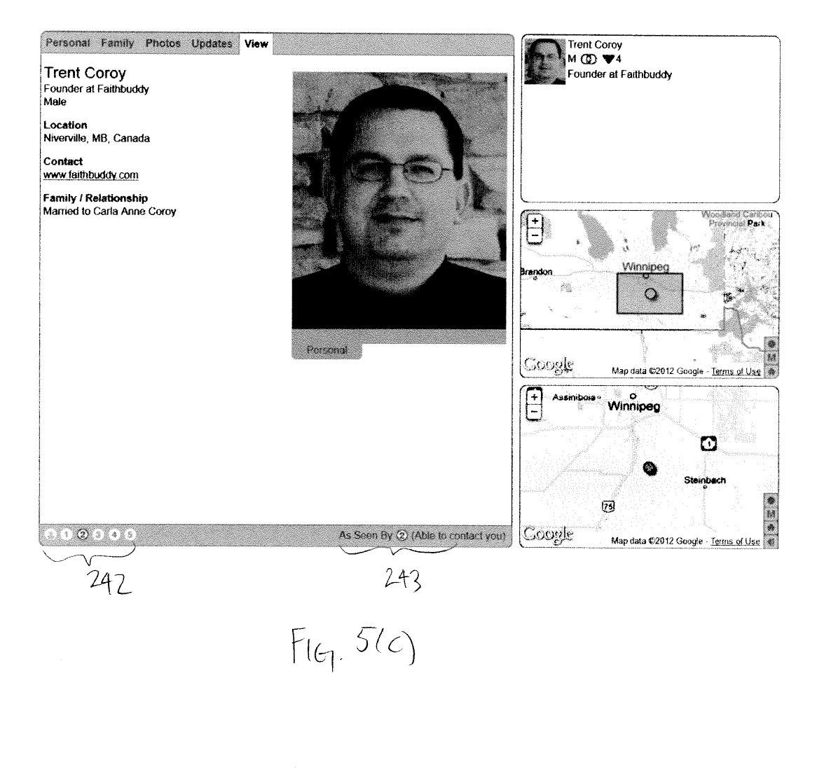

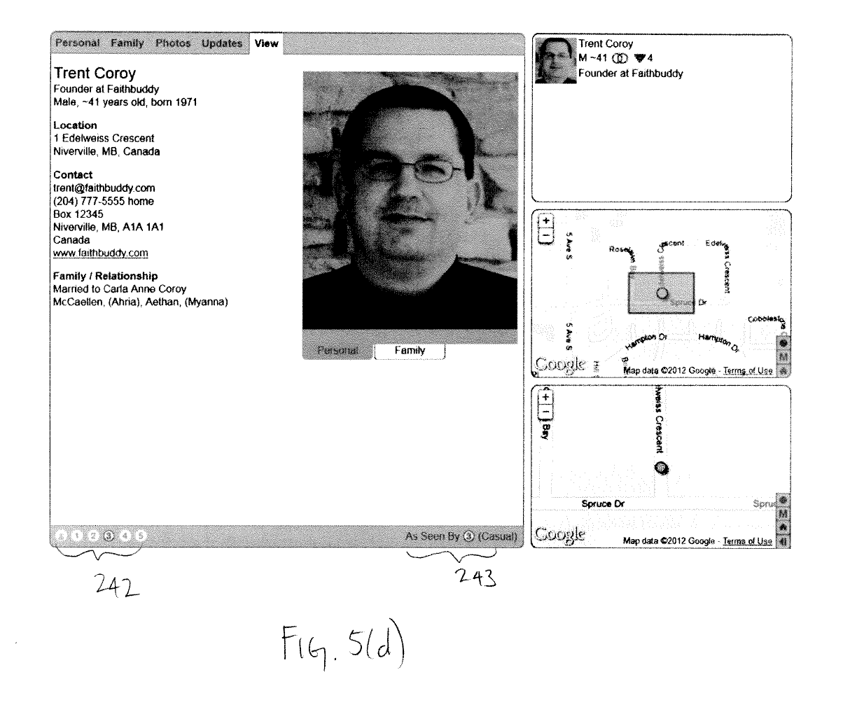

FIGS. 4(a)-(b) illustrate portions of an exemplary contact list display 400 which can be used by a first member to i) assign direct permission levels to other member/non-member recipients to govern access to information types 210 in the first member's profile 200, and ii) grant a contact permission to other member/non-member recipients to control who can contact the first member through the social network 100. Direct permission levels may be assigned, and contact permissions may be granted to recipients, which comprise both members and non-members of the social network 100.

As shown in FIG. 4(a), the contact list display 400 comprises a contact list 402 of members/non-members, each identified by a handle 406 and having associated summary contact information 412. As shown, each member/non-member's handle 406 comprises their name, and his or her summary contact information 412 may comprise their email address and phone number. In other embodiments however, these values may comprise other unique identifiers for identifying and contacting each member/non-member on the contact list 402. Each member/non-member in the contact list 402 has an associated contact record comprising various types of contact information. One or more contact links 414 may be provided for the first member to access these contact records and to view, enter and/or edit contact information for each member/non-member on his or her contact list 402. Further, each member/non-member on the contact list 402 may be assigned a direct permission level which is indicated to the first member through a permission level icon 404. As will be discussed in greater detail below, the contact list 402 may comprise member/non-member groups (not shown) to which the first member may also assign group permission levels; individual member/non-members who are part of a group may inherit the group permission level to access the first member's profile 200.

### Direct Permission Levels

Still referring to FIGS. 4(a)-(b), the first member may assign direct permission levels to each member/non-member on his or her contact list 402 through the contact list display 400. A permission level (for example a direct permission level or an effective permission level determined by an inheritance rule) for a member/non-member, which may be a default permission level, is indicated through a permission level icon 404 adjacent to the member/non-member's handle 406 on the contact list 402. In the following embodiments, a recipient that has been assigned a direct permission level from the first member will have access to information types 210 on the first member's profile 200 with a corresponding or lower privacy level. However, in embodiments involving group inheritance (described further below), an effective permission level may alternatively be calculated to determine the recipient's ability to access the first member's information types 210 on his or her profile 200.

Direct permission levels are assignable through a permission control region 410, which can be accessed by the first member by interacting with (for example, moving a mouse cursor over, or clicking on) the permission level icon 404 of a particular member/non-member on the first member's contact list 402. As shown in FIG. 4(b), the direct permission levels that may be assigned to a member/non-member include “public”, “0”, “1”, “2”, “3”, “4”, and “5”. These direct permission levels may have corresponding permission scores of 0, 0, 1, 2, 3, 4 and 5, respectively, which may be used when determining an effective permission level in embodiments involving inherited group permission levels (discussed further below). In FIG. 4(b), a direct permission level of “public” is shown as the default or “unassigned” value, which allows a member/non-member recipient to access and view any of the first member's information types 210 set to a “public” privacy level, and also allows the member/non-member to inherit any group permission level that may grant access to the first member's profile information. A direct permission level of “0” however, will “blacklist” a member/non-member on the contact list 402, limiting his or her access to the first member's profile information to only information types 210 set to a “public” privacy level regardless of any group permission level that the member/non-member may inherit through a group. Assigning a direct permission level of “1”, “2”, “3”, “4”, or “5” provides the member/non-member with permission to view the first member's information types 210 with privacy levels set to a corresponding or lower value, but in some embodiments may prevent the member/non-member from inheriting group permission levels. For example, a member/non-member that has been assigned a direct permission level of “3” may view the first member's information types 210 having a privacy level of “3” or lower, and is prevented from inheriting any group permission levels for accessing the first member's profile information. Therefore, only members/non-members with a direct permission level of “public” can inherit group permission levels for accessing the first member's profile information in this example (described in more detail below).

When a recipient (who may be a member/non-member on the first member's contact list 402) attempts to view the first member's profile 200, the system compares any permission level assigned by the first member to the recipient to the privacy levels of the first member's information types 210, and determines which, if any, of the first member's information types 210 are accessible by the recipient for display. For example, “Dummy One” in FIG. 4(a) has been assigned a direct permission level of “2” by the first member (shown through permission level icon 404); accordingly, this direct permission level is sufficient for Dummy One to access the first member's information types 210 with a privacy level of “2” or lower. As another example, “McCaellen Coroy” has a direct permission level of “public” (indicated by a silhouette permission level icon 404), which may be a default direct permission level for members/non-members on the contact list 402, or may be a direct permission level assigned by the first member. Accordingly, McCaellen Coroy can only view the first member's information types 210 set to a “public” privacy level on his or her profile 200.

The permission level icon 404 may provide the first member with additional information besides indicating a permission level. For example, as shown in FIG. 4(a), the circle surrounding the direct permission level “2” for the permission level icon 404 for “Dummy One” indicates that “Dummy One” is visible as a member of the social network 100 with a registered account. However, in other embodiments (not shown), different icons or indicators may be used to communicate other types of information.

In other embodiments, permission level icons 404 and/or permission control regions 410 may be implemented in other ways than that shown for contact list display 400 in FIG. 4(a). For example, a summary profile 250 (shown in the top right corner of FIG. 4(a), for example) may include a permission level icon 404 and a notification icon 413, and may be provided in the contact list display 400 or other profile displays where member/non-member contacts are listed. Such wide provision across various contexts allows a first member to easily view and change permission levels and other settings as desired.

### Group Permission Levels and Inheritance

As eluded to above, the contact list 402 or some other list may comprise groups of members/non-members to which the first member may assign group permission levels. An individual member/non-member who is part of the group may inherit a group permission level assigned by the first member to that group; an inherited group permission level may provide the member/non-member access to the first member's profile information. For example, a member/non-member who has inherited a group permission level of “2” assigned by a first member to the group, may access the first member's information types 210 which have a corresponding privacy level of “2” or lower. Similarly, a group permission level of “3” may provide access to the first member's information types 210 with a privacy of “3” or lower, and so forth.

In certain embodiments however, an inheritance rule may be applied to determine an effective permission level, which is alternatively used to determine a member/non-member's ability to access the first member's information types 210 instead of a direct permission level or group permission level individually. In the following examples which illustrate the determination of effective permission levels, group permission levels comprise “public”, “1”, “2”, “3”, “4” and “5”, with corresponding permission scores of 0, 1, 2, 3, 4, and 5, while direct permission levels comprise “public”, “0”, “1”, “2”, “3”, “4”, and “5”, with corresponding permission scores of 0, 0, 1, 2, 3, 4 and 5.

According to one inheritance rule, the effective permission level corresponds to one of the direct permission level assigned to the member/non-member, or group permission level inherited by the member/non-member, which has a higher permission score. For example, if the member/non-member has been assigned a direct permission level of “3” having a permission score of “3”, and has also inherited a group permission level of “2” having a permission score of “2”, the member/non-member's effective permission level will be “3”, which will allow the member/non-member to access the first member's information types 210 which have a privacy level of “3” or lower.

In other embodiments direct permission levels may further comprise at least two inheritance types which control whether a member/non-member on the first member's contact list may inherit a group permission level for accessing the first member's profile information. They are: 1) inheritance permitting—this inheritance type allows a member/non-member who has been assigned such a direct permission level by the first member to also inherit group permission levels for accessing the first member's profile information, and 2) inheritance preventing—this inheritance type will prevent a member/non-member who has been assigned the direct permission level by the first member from inheriting group permission levels permitting access the first member's profile information Inheritance types may be determined according to the direct permission level (for example, only direct permission levels of “public” may be inheritance permitting) or a corresponding permission score (for example, only direct permission levels corresponding to a permission score of “0” may be inheritance permitting).

For example, a permission score may be implemented with at least two direct permission levels corresponding to that permission score, including at least one level which is inheritance permitting and at least one level which is inheritance preventing. As described above, in some embodiments a direct permission level of “public” corresponding to a permission score of 0 (i.e. only able to see public information) may allow inheritance of group permission levels, while a direct permission level of “0” corresponding to a permission score of 0 may disallow inheritance of group permission levels. The “public” direct permission level or setting may be the default permission level for a member/non-member. The “0” direct permission level or setting may be selected by a first member to “blacklist” another member/non-member, preventing them from having access to any of their profile information that is not public. In some embodiments selecting a “0” direct permission level may also prevent a member/non-member from being able to contact the first member through the social network 100. Direct permission levels “1”, “2”, “3”, “4” and “5” may also be inheritance preventing.

In this example, according to an inheritance rule, when the direct permission level is not “public” the effective permission level corresponds to a direct permission level, and overrides any inherited group permission level by the member/non-member. For example, if the member/non-member has been assigned a direct permission level of “2” by the first member, and has also inherited a group permission level of “3”, the member/non-member's effective permission level will be “2” despite having inherited a higher group permission level. This limits the member/non-member's access to information types 210 of the first member's which have a privacy level of “2” or lower. Similarly, if the member/non-member has inherited a group permission level of “3”, and has been assigned a direct permission level of “4” by the first member, the member/non-member's effective permission level will be “4”. This type of inheritance rule therefore allows the first member to individually manage and control how members/non-member's on his or her contact list may access to his or her profile information, regardless of any group permission levels that the member/non-member may be eligible to inherit. Different inheritance rules may be applied in other embodiments, and any suitable range or format of direct permission levels, group permission levels, or permission scores may be alternatively used.

In embodiments where group permission levels may be inherited, the permission level icon 404 may illustrate the effective permission level, and may distinguish inherited group permission levels from direct permission levels. For example one or more different colors might be used, or a distinguishing icon may be displayed, to differentiate between inherited group permission levels and direct permission levels.

### Contact Permissions

Referring to FIGS. 4(a)-(b), the first member can grant contact permission for other member/non-member recipients to contact the first member over the social network 100 via contact list display 400. Contact permission can be granted to a particular recipient by interacting with (for example, clicking on) a contact granting icon (not shown) adjacent to the particular member/non-member on the contact list 402. Conversely, other members may grant contact permission to the first member for contacting them via a similar contact list display. Recipients may be granted contact permission regardless of whether they are members or non-members of the social network 100.

In the embodiment of FIGS. 4(a)-(b), a contact permission icon 408 is shown to indicate whether the first member has been granted contact permission to communicate with the corresponding member/non-member on the first member's contact list 402. In certain embodiments, the first member must be granted contact permission to communicate with a certain member/non-member, and may also have to meet any additional contact requirements implemented for the social network 100. Additional contact requirements may include account type requirements, age requirements, and/or other requirements. However, contact permissions may be granted as an exception (for example, as a contact override, as will be described below).

As shown in the embodiment of FIGS. 4(a)-(b), the contact permission icon 408 has a solid envelope outline to indicate that the first member has been granted contact permission to contact the corresponding member/non-member on the contact list 402 over the social network 100. A solid envelope icon may also be interactive (e.g. clicked on) to provide a shortcut for composing a message to that member/non-member. When the envelope icon is absent, the first member cannot contact that corresponding member/non-member; this may indicate a lack of contact permission, or may simply indicate that the contact record fails to include contact details (such as an email address) to facilitate communication. An envelope icon with a dashed outline indicates that the first member has already communicated to the member/non-member some number of times, perhaps making use of contact overrides (described below), and that the member/non-member must now grant contact permission to the first member before further communication will be allowed. In other embodiments however, the contact permission icon 408, or other suitable icons, may be implemented in other ways to indicate the above features.

As a further example referring to FIG. 4(a), the contact permission icon 408 shown as a solid envelope next to “McCaellen Coroy” indicates that the first member has been granted contact permission to contact this member/non-member through the social network 100. In contrast, the lack of any envelope icon next to “Dummy One” indicates that the first member is not allowed to contact this member/non-member. The dashed envelope icon next to “Ahria Coroy” indicates that the first member may not further communicate with this member/non-member unless he or she is granted contact permission from this member/non-member.

In some embodiments the first member may directly grant contact permission to a member/non-member recipient on his or her contact list 402 through the use of contact permission settings and controls (not shown), which may be associated with the member/non-member's contact record. In other embodiments, contact permission may be determined based on a permission level and a contact permission level. For example, recipients granted a permission level for the first member equal to or greater than the first member's contact permission level have permission to contact the first member, and members/non-members granted a permission level for the first member lower than the first member's contact permission level do not have permission to contact the first member. In some embodiments the contact permission level may be configurable by members for their own profiles. In other embodiments, contact permission levels may be set in a standard way for all members on the social network 100. In some embodiments there may be multiple contact permission levels, each corresponding to permission for a different method of contact (e.g. email, posting, message, etc.).

Using the contact list display 400, the first member may assign direct permission levels and grant contact permissions to recipients on his or her contact list 402. Communication to a particular non-member is facilitated by their contact record when it comprises at least one supported unique identifier. Examples of supported unique identifiers include email addresses, phone numbers, or application user names including those for Facebook™, Twitter™, and Skype™. The contact list display 400 may also include a list of member/non-members (not shown) which may serve as a distribution list to facilitate communication with multiple contacts at a time.

### Automatic Contact Permission Granting

Interactions initiated by a first member of the social network 100 to another member/non-member may indicate a level of trust, familiarity, or camaraderie between them. Accordingly, the disclosed privacy and permission system is capable of determining communications involving members/non-members through the social network 100 and appropriately granting contact permissions to reflect the state of the relationship between them.

For example, in one exemplary embodiment, the first member sends a communication or message through the first terminal 102, to a recipient using the second terminal 104, via the network 106. The recipient is initially prevented from contacting the first member because he or she has not been granted contact permission to reply to the first member's communication. Accordingly, the disclosed privacy and permission system determines whether a message has been sent from the first member to the recipient, and when the message has been sent from the first member to the recipient, grants the recipient an appropriate contact permission to reply to the first member's message.

In other embodiments, the privacy and permission system determines whether it is appropriate to grant contact permission to the recipient in accordance with a specific metarule. The metarule may be selected according to the specific transmission type used by the first member (for example, a private message, an email, a posting, a system notification, etc.), and may consider one or more information types 210 from the first member or the recipient's profiles before determining whether it would be appropriate to grant contact permission. In one example, the first member is a minor, and the recipient is an adult in a different geographical area. In this example, the metarule determines that it is inappropriate to assign the recipient contact permission to contact the first member based on the relative age and location differences. Therefore, the privacy and permission system does not grant the recipient contact permission to contact the first member in this example. In other embodiments however, the metarule may consider any number of information types 210 in the profiles or accounts of the first member and the recipient to determine whether or not to grant contact permission.

In yet another embodiment, the privacy and permission system automatically grants the recipient contact permission to contact the first member in accordance with a “contact override” feature. The system may apply a “contact override” to grant contact permission to a recipient regardless of whether the first member has granted a contact permission to the recipient. For example, the system may determine that the first member is a minor and the recipient is a verified parent or legal guardian of the first member, and in this case the system may then provide a contact override which permits the recipient to contact the first member. In another example, the system accesses a communication from the recipient to the first member, and determines information types from the communication. The system then compares the information types from the communication to the first member's information types 210. If the information types from the communication sufficiently or substantially match the information types 210 from the first member's profile, the system may then grant the recipient contact permission to contact the first member over the social network 100. The contact override feature may therefore grant the recipient with contact permission if he or she correctly provides one or more information types 210 from the first member's profile 200. For example, if the recipient enters the same or substantially the same information types 210 into a contact record for the first member, then the recipient may be granted contact permission to contact the first member.

In some embodiments, a contact override feature may provide contact permission to a recipient based at least in part upon a set contact permission or assigned permission level by the first member for the recipient. Further to the above example, the system may provide a contact override which permits the recipient to contact the first member if he or she correctly knows one or more information types 210 from the first member's profile 200, and if the direct permission level of the recipient meets a contact override criteria such as being set to a “public”, “unassigned”, or a default level. In another example, where the first member has set a non-default contact permission or direct permission level for the recipient that prevents or “blocks” the recipient from contacting the first member, the privacy and permission system does not grant the recipient a contact override to contact the first member.

Accordingly, the contact override feature provides a simplified means for establishing communications involving members/non-members over the social network 100, and helps to establish initial interactions where they might otherwise be prevented from contacting each other.

In some embodiments, the contact override feature may only grant the recipient contact permission to contact the first member for a threshold number of communications. Once the recipient has met this threshold, the first member must directly grant contact permission in order for the recipient to continue communicating with the first member over the social network 100. Contact overrides for different members/non-members may share a common threshold number of communications, such that further communications are prevented once the threshold number of communications is met. For example, the first member may be allowed to send a message directly to a recipient based on the first member's knowledge of that recipient's email address. However, after a certain number of communications, the first member may be prevented from making further communications until that recipient grants the first member contact permission for further communications.

### Automatic Assignment of Direct Permission Levels and Permission Overrides

The disclosed privacy and permission system is also capable of automatically assigning direct permission levels based on various communications involving members/non-members over the social network 100. Automatically assigning direct permission levels can help nurture relationships involving members/non-members of the social network 100, as it may provide a commensurate or measured level of access to each other's profile information to facilitate relationship development.

For example, the first member may use the first terminal 102 to transmit a message to the recipient using the second terminal 104 via the network 106. In this case, the privacy and permission system determines that a message has been sent from the first member to the recipient, determines a direct permission level from the message, and assigns the direct permission level to the recipient which may allow the recipient to view certain aspects on first member's profile 200. More specifically, the direct permission level allows the recipient to view the information types 210 of the first member's profile 200 that have associated privacy levels (that may be selected through privacy level sliders 320, for example) satisfied by the assigned direct permission level. In one embodiment, the first member's privacy level for a given information type 210 is satisfied if the recipient's permission level meets or exceeds the first member's privacy level for the given information type 210. However, in other embodiments, privacy levels for the first member's information types 210 may be satisfied in other ways to determine whether the recipient may access those information types 210 using an assigned permission level.

In one embodiment, the system may determine and access a communication sent from the first member to the recipient, determine a direct permission level to be a default level (for example, “2”), and assign the default direct permission level to the recipient. In other embodiments, the direct permission level may be determined in accordance with a metarule. The metarule may be selected according to the specific communication type between the members/non-members (for example, a private message, an email, a posting, a notification, etc.), and may consider various data, such as one or more information types 210 from the profiles 200 of both the first member and recipient, or the conversation history between them, before determining an appropriate direct permission level for assigning to the recipient. For example, the privacy and permission system may apply the metarule by comparing the information type 210 entitled “interests” between the first member and recipient; if the “interests” of both substantially match, the system may determine that the appropriate direct permission level is one that allows the recipient to access or view the first member's “interests” in his or her profile 200. In another example, the system may apply a metarule that compares information types 210 entitled “age” or “birthdate” of both the first member and the recipient; if the first member is a minor, and the recipient is an adult, the system may determine that a relatively low direct permission level, or “blacklisted” direct permission level that blocks access, is appropriate for assignment. In another example, the system may evaluate the history and duration of interactions involving members/non-members according to a metarule; if there is a substantial interaction or conversation history, the system may determine that a relatively higher direct permission level is appropriate. In another example, the system may take into account any inherited group permissions the recipient may have in determining a direct permission level, to avoid decreasing the recipient's effective permission level. Accordingly, the system can apply various metarules to dynamically determine appropriate direct permission levels that may be assigned to the recipient, in accordance with profile data or other system data and variables of the social network 100.

In another embodiment, the privacy and permission system may track communications involving members/non-members in order to determine the appropriate direct permission level for assignment. For example, if first member has voluntarily disclosed one of his or her information types 210 to the recipient, the system may assign a direct permission level that at least corresponds to the privacy level set for this disclosed information type such that the recipient may see this information type 210 when accessing the first member's profile 200. By determining communications from the first member to the recipient, and determining privacy levels associated with each of the disclosed information types 210 in the communication, the system may assign a direct permission level to the recipient which satisfies the privacy level associated with the disclosed information type. In this way, the recipient can easily access this information on or through the first member's profile 200 without the need to search through the communication content or inquire further.

In some embodiments, the system may automatically assign permission to a recipient to access one or more of the first member's information types 210 on the first member's profile 200, regardless of any permission level assigned by the first member to the recipient. This may be referred to as a permission override, and is discussed below.

### Permission Overrides

Automatic permission assignment may function by way of a permission override feature, which can bypass permission level based restrictions to allow a recipient to access the first member's information types 210 through messages involving the first member. For example, messages over the social network 100 may draw a sender's information types 210 for display within a header of a message when the message is sent to a recipient. The information types 210, may be drawn from a member/non-member's profile, or from their account profile information. Accordingly, if a first member sends a message to the recipient over the social network 100, which discloses at least one of first member's information types 210, the system may automatically assign a permission override to the recipient for accessing a disclosed information type, such that the recipient may continue to access the already disclosed information type in the message, or any subsequent responses to the message.

In one embodiment where a communication sent from a first member to a recipient draws certain information types 210 from the first member's profile 200 within the communication, the system will compare the privacy levels associated with the drawn information types to the recipient's permission level, and determine whether to disclose the information types to the recipient in the communication. If the recipient's permission level is insufficient to access the drawn information types in the communication, the system may then implement a permission override to allow the recipient access to the information types disclosed in the communication. Communications may comprise for example, a message, a message thread, or a posting.

In another embodiment, if the first member discloses his or her “name” in a communication, and subsequently changes the privacy level for his or her “name” such that the recipient no longer has sufficient permission to view the first member's “name”, the permission override may assign the recipient a permission override to allow continued access to the first member's “name” when subsequently viewing the same communication. Accordingly, permission overrides can be implemented to help ensure that the first member's information types 210 remain accessible to a recipient upon being disclosed, even if the first member changes the privacy level for a disclosed information type 210, or assigns a lower direct permission level to the recipient to block access to a disclosed information type 210. In some embodiments, the system may associate a static historical value for information types 210 such as a “name” when disclosed in a message, message thread, or communication, or may simply allow access to current “name” information drawn from the first member's profile 200.

In another embodiment where a communication sent from a first member to a first recipient is forwardable from the first recipient to a second recipient, and the first member has disclosed an information type 210 in the communication to the first recipient, the system may apply a permission override to allow the second recipient access to the disclosed information type 210 in the communication received by the first recipient. For example, the first member may have revealed his or her “name” in a message sent to the first recipient. The first recipient may subsequently forward or share the message with a second recipient. In this case, the system may apply a permission override to ensure that the second recipient can access the first member's “name” when viewing the message. Permission overrides may also be applied when the message is successively forwarded or shared to ensure that any member/non-member who receives the message may have access to the first member's “name” when viewing the message. A permission override may operate to provide access regardless of any permission levels assigned by the first member, or any changes the first member may make to the privacy level associated with the disclosed information type.

Permission overrides may be applied separately for different information types 210, such as different types of “name” information. For example, a message belonging to a message thread sent from a first member to a recipient may draw the first member's first name from his or her profile 200 within the message and message thread; a permission override may therefore provide the recipient access to the first member's first name only when viewing the message and message thread. A subsequent message in the message thread from the first member to the recipient may further draw the first member's last name within the message and message thread, in which case an additional permission override may provide the recipient access to the first member's last name when viewing the subsequent message and message thread.

### Profile View

The disclosed privacy and permission system also provides a profile view interface that allows the first member to easily and readily view how his or her profile 200 would be shown to other members/non-members of the social network 100 having different permission levels. For example, the first member may wish to view how his or her profile page 200 would appear to a recipient who has been granted a permission level of “2” by the first member. Accordingly, the profile view interface would display to the first member his or her profile page 200 containing only information types 210 with privacy levels satisfied by a permission level of “2” (for example, information types 210 with a privacy level of “2” or lower); other information types 210 are not shown in this example.

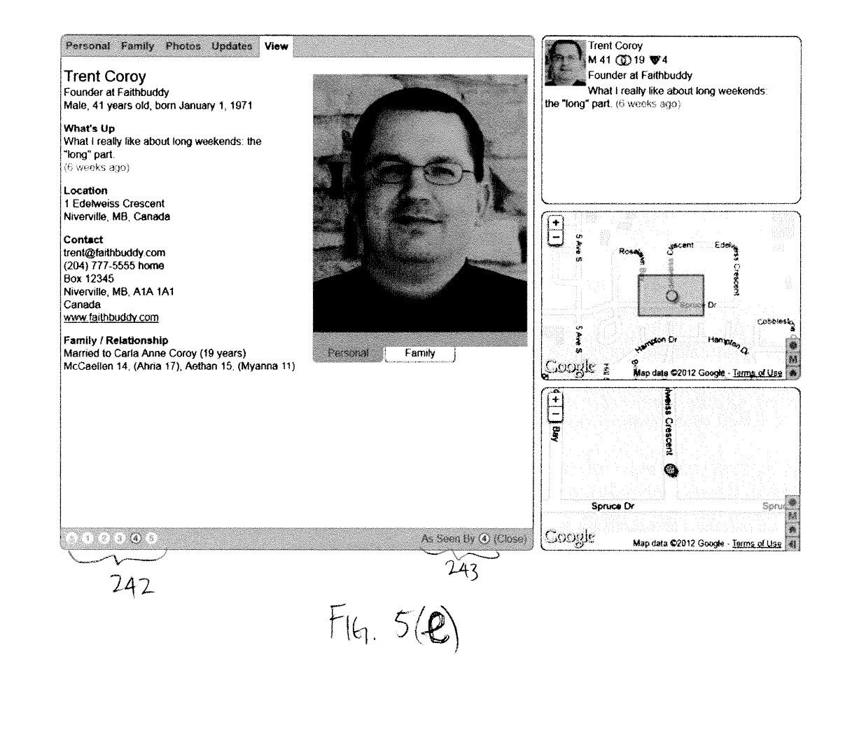

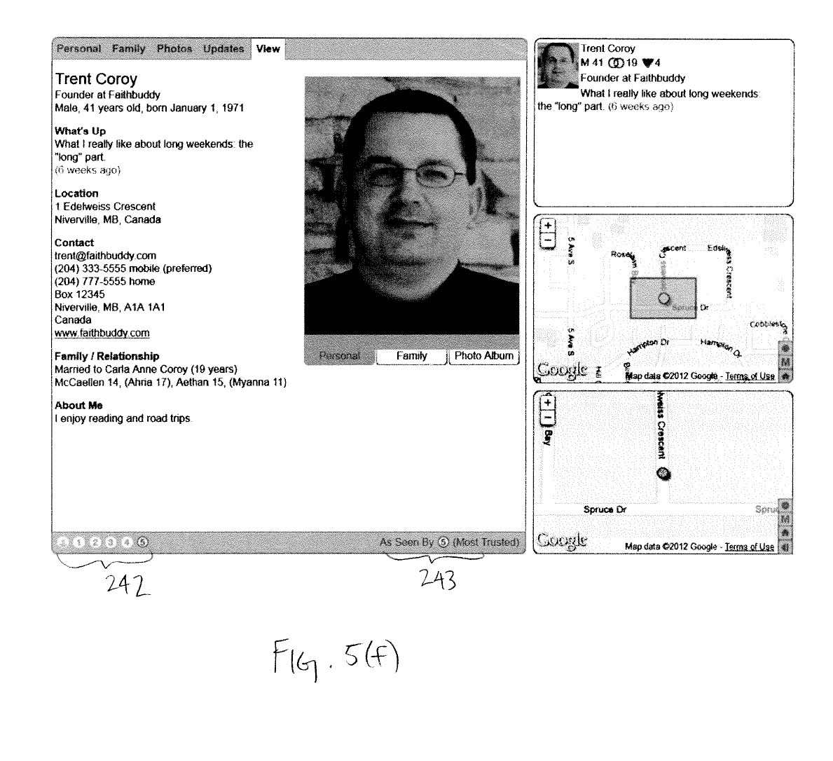

A method for viewing the display of a first member's profile is described as follows. The privacy and permission system receives a proposed permission level from the first member for viewing his or her profile 200. The system then compares the privacy levels of the first member's information types 210 to the proposed permission level. Then, the system displays to the first member a profile 200 comprising his or her information types 210 that have their privacy levels satisfied by the proposed permission level. This process allows the first member to easily see how his or her profile 200 would appear to other members or non-members having different permission levels. This process is also useful for reviewing changes made to any of the first member's privacy levels for his or her information types 210. As shown in FIGS. 2 and 5(a)-(f), a control region 242 is displayed in the profile view interface, that is presented to the first member for selecting proposed permission levels. A description of how a proposed permission level may correspond to a permission level assigned to another member or non-member, when viewing the first member's profile 200, may be displayed in a proposed permission level mapping display (not shown).

FIGS. 5(a)-(f) are different embodiments of the first member's profile views, which show to the first member how his or her profile 200 would appear to others having different assigned permission levels. The first member may select a proposed permission level from the control region 242. For example, in FIG. 5(a) the proposed permission level is set to “public”; accordingly, the system determines the first member's information types 210 which have a “public” privacy level, and displays a profile view to the first member comprising those information types 210 with a “public” privacy level. In the example of FIG. 5(a), no personal information of the first member is disclosed at a permission level corresponding to this proposed permission level. In FIG. 5(b), the proposed permission level is set to “1”; accordingly, information types 210 with a privacy level of “1” and below are displayed to the first member, which in this case corresponds only to the first member's first name, occupation, gender, province, country, website, relationship status, personal image, and number of children. Similarly, FIGS. 5(c)-(e) show profile views which include other information types 210 corresponding to higher privacy levels as the proposed permission level escalates. Finally, FIG. 5(f) shows a profile view of the first member comprising all non-hidden information types 210, as the highest proposed permission level of “5” has been selected in this example. As shown in FIGS. 5(a)-(f), the proposed permission control region 242 is placed in close proximity to the profile view display to improve user experience and ease of use.

In other embodiments (not shown), the first member may further select or adjust privacy levels corresponding to his or her different information types 210 without leaving the profile view. While the privacy level sliders 320 for selecting privacy levels are shown beside corresponding information types 210 on profile input page 300 of FIG. 3, they may be placed in additional or other locations in other embodiments.

In some embodiments, the first member may be able to make unconfirmed changes to their profile such as values for information types 210 and/or privacy levels, and to preview the effects of those unconfirmed changes using one or more profile views with one or more different selected proposed permission levels, prior to confirming the changes and having them take effect.

### Automatic Account Reservation

The disclosed privacy and permission system is also capable of automatically reserving an account for a non-member of the social network 100 based on a first member's actions over the social network 100. For example, the first member may send a message through the social network 100 to a non-member that is currently unregistered on the social network 100 (e.g. an individual, entity, or group who does not have registered account, whether or not they have accessed the social network). The message may be sent using a contact record for the non-member, which has been created by the first member in his or her contact list. As described above, contact records may comprise a unique identifier such as an email address or a phone number. The system may determine a unique identifier from the message, and automatically generate a reserved account for the non-member using the unique identifier.

In other embodiments, the first member may instead simply enter the non-member's email address directly into a message, such as in a send list (i.e. list of intended message recipients). As above, the system may determine the email address from the message and automatically generate a reserved account for the non-member's using the email address entered directly in the message. The system may also automatically add the non-member to the first member's contact list 402 with a contact record including the email address.

Automatic profile reservation may also be coupled with other features, such as automatic direct permission level assignment, contact permission granting, and/or creation of a contact records associated with the non-member. For example, the system may generate a contact record for the non-member on the first member's contact list 402 comprising an email address or another unique identifier used by the first member to contact the non-member. The system may also automatically determine and grant contact permission to the non-member, and/or automatically determine and assign a direct permission level to the non-member.

Another feature that may be coupled to a reserved account is a message storage feature. This may be useful for embodiments where the non-member is unable to fully receive messages from the first member until he or she has registered with the social network 100. For example, when the first member sends a message to the non-member, the system may intercept and hold the message under the reserved account. When the non-member registers with the network 100, the system will then deliver the message to the newly registered account of the now registered member. Prior to delivering the message, the system may deliver various notices to the non-member to invite him or her to register as a member of the social network 100. The notice may include a portion of the message held for the non-member, wherein other portions of the message may only be accessible upon registering with the network 100. The portion of information disclosed in the notice may be determined according to various system data, such as the first member's information types 210, and any direct permission level or contact permission assigned by the first member to the non-member. For example, the notice may include information types 210 drawn from the first member's profile 200 having corresponding privacy levels commensurate with any direct permission level assigned to the non-member. As another example, the notice may include various links to view information on the social network 100; when the non-member accesses these various links, information types 210 may be drawn from the first member's profile to the non-member, according to the privacy levels of the information types 210 and the direct permission level assigned to the non-member. In some embodiments, these links may be used by the non-member without the need to register an account on the social network 100.

In certain embodiments, the system may intercept or determine a communication sent by the first member to the non-member, determine whether a contact permission or direct permission level has been assigned to the non-member, and grant contact permission (new, revised, or otherwise) or assign a revised direct permission level to the non-member. For example, contact permission may be granted to the non-member so that he or she may reply to the first member's message, should the non-member register an account with the social network 100 and become a registered member.

When the non-member registers with the social network 100, and provides an email address or other supported unique identifier, the system will check for an account reserved for the new member associated with the unique identifier. If the system determines that an account has been reserved account for the new member, the system then transfers account information and/or attributes from the reserved account to the new member's newly registered account as appropriate. For example, any messages stored for the new member under the reserved account may be transferred to the new member's new account upon registering with the network 100.

The following is another example of the system automatically reserving an account for a non-member based on a first member's actions. The first member may grant contact permission and/or assign a direct permission level to a non-member that is currently unregistered on the social network 100. For example, the first member may create a contact record for the non-member comprising an email address, or any supported unique identifier. As described above, the first member may then also assign a direct permission level or grant contact permission to the non-member, such that the non-member may contact the first member, or access his or her profile 200 upon registering. The system may then automatically generate a reserved account associated with the non-member's email address or other supported unique identifier if an account associated with the same information does not already exist.

### Automatic Privacy Level Updating

The disclosed privacy and permission system is also capable of updating the selection and display of privacy levels for certain information types on their privacy level sliders 320, according to the privacy levels set for the first member's other information types 210, and/or other information associated with the first member's account.

In one embodiment, the system may prevent the privacy level for the information type “Last Name” from being set lower than the privacy level for the information type “First Name”. This may be implemented by preventing the first member from making privacy level changes that create an invalid configuration (for example, according to various metarules). In one example, when the first member changes the privacy level of his or her “Last Name” to a proposed privacy level, the system will compare the proposed privacy level to the privacy level set for the first member's “First Name”. If the proposed privacy level is lower than the privacy level for the first member's “First Name”, the system will reject the change. The system may further provide a corresponding message and/or other indication related to the rejection. However, if the proposed privacy level is equal to or higher than the privacy level for the first member's “First Name”, the system will change the privacy level for the first member's “Last Name” to the proposed privacy level. In another example, after the first member sets a privacy level for his or her “First Name”, the system will update the selectable options of privacy levels that are displayed through privacy level sliders 320 for his or her “Last Name” to prevent the first member from selecting any privacy levels lower than that of the “First Name”.

The updated display and selection of privacy levels on privacy level sliders 320 for certain information types 210 may also be performed in response to a privacy level change for a certain information type 210. In an embodiment where the privacy level for “First Name” must be equal to or lower than that for “Last Name”, for example, and the privacy level for “Last Name” is set to “2”, the system may display possible privacy level options on privacy level sliders 320 for “First Name” as “Public”, “1” and the “2”. The system may further provide messaging and/or other indication to the first member to indicate that selecting a “Public” privacy level for “Last Name” will cause an additional privacy level change for “First Name” as well. Then if the privacy level for “Last Name” is changed from “2” to “Public”, the system will automatically adjust the privacy level for “First Name” to “Public” as well.

In another example, the system may not allow the selection of “Public” privacy level when the first member's information types 210 “Birthday” and “Birth Year” indicate the first member is underage or a minor, and/or when the first member's account type is an account type that does not allow public profiles. For example, the system may exclude of the option of selecting a “Public” privacy level from privacy level sliders 320 when the first member's information types 210 indicates that he or she is underage or a minor.

In another example, the system may automatically determine privacy levels for certain information types 210 based on other information types 210, and update the privacy level sliders 320 to indicate these privacy levels. Referring to FIG. 3 for example, the privacy levels for information types “Gender”, “Physical Address Province/State”, and “Physical Address Country” are automatically determined by the system, and may not be selected by the first member through corresponding sliders 320. In this example, if the system determines that certain information types 210 have a privacy level of “1” or higher, the system will then set the privacy levels for “Gender”, “Physical Address Province/State”, and “Physical Address Country” to be “1”. If the first member selects a privacy level of “Public” for certain information types 210, the system will correspondingly change the privacy levels for “Gender”, “Physical Address Province/State”, and “Physical Address Country” to “Public” as well. For example, if the first member has a public (non-anonymous) profile but then selects a privacy level higher than “Public” for all information types 210 where the first member is permitted to adjust a privacy level, then the system may change the privacy level for “Gender”, “Physical Address Province/State”, and “Physical Address Country” from “Public” to “1” so that the first member has a non-public (anonymous) profile.

Accordingly the display and selection of privacy levels for certain information types 210 may be a function of one or more aspects of the first member's profile information, including other information types 210 and their associated privacy levels, and/or any other information associated with the first member's account. In this way, the system is able to provide simple and intuitive display and selection of privacy levels through privacy level sliders 320, while enhancing security, safety, and social interactions through the social network 100.

A method for updating the display and selection of privacy levels follows. The system first detects a change to a first member's account on the social network. The change may comprise a change to the first member's profile 200 including any information types 210, privacy levels for information types 210, account type or status, an attribute that may be calculated based upon information from the first member's profile 200, or an external change which results in a change in a calculated attribute associated with the first member. The system then determines updated privacy levels and a suitable selection of privacy level slider 320 options for the first member's information types 210 according to the above change. Afterwards, the system updates the privacy level sliders 320 to display the updated privacy levels and to provide the suitable selections of privacy levels which the first member may select.

In an example where the system changes the display and selection of privacy levels based on a change to the first member's information types 210, the system may calculate the first member's “Age” based on his or her information types 210 for “Birthdate” and “Birth Year” and the current date, from which the first member's “Age” is thereafter (continually or periodically) updated on the network 100. If the first member's “Age” increases beyond the threshold for being a minor or underage, the system may detect this change and now allow the first member to select “Public” privacy levels for certain information types 210. The system then updates the first member's profile input page 300 to allow selection of “Public” privacy levels on the sliders 320 of those certain information types 210. In this way, the first member's privacy level sliders 320 are dynamically updated, which streamlines selection of suitable privacy levels and enhances the first member's experience using the social network 100.

### Notification Features Using Permission Levels

The disclosed privacy and permission system is capable of using permission levels and/or “following” information in the management of notification preferences. For example, in FIGS. 4(a)-(b) the first member may select that they are following or not following a contact by interacting with the following icon 413. In this example, a white or empty star indicates the first member is not following the contact, while a gold or full star indicates the first member is following the contact. Following icons 413 may be provided in contexts other than the contact list display 400. As examples, following icons 413 may be provided in profiles 200, summary profiles 250 (for example as shown in the top right corner of FIG. 4(a)), and other contexts where members/non-members or contacts are referred to in some way. Such wide provision across various contexts allows members/non-members to easily view and change following preferences as desired.

Additionally, the disclosed system is capable of using black lists and/or white lists in the management of notification preferences. In general notification preferences may be configurable for various purposes, and may govern both whether or not a particular type of notification is sent, and also by what means such a notification should be sent. Some examples of notification means are email notices, text message notices, pager notices, and Facebook™ message notices.

In some embodiments, the system may be able to provide notices when a first member receives a message or communication on the social network 100, which may be of a specific type. For example, the first member may set his or her notification preferences to block or ignore notices for certain messages or communication types. Conversely, the first member may be able to set his or her notification preferences to receive notices for certain messages or communication types. The first member may be able to set his or her notification preferences to receive a notice only if they are following the sender. The first member may be able to configure notification preferences to receive a notice only if they have granted the sender a permission level equal to or greater than a selectable threshold. The first member may be able to configure notification preferences to receive a notice only if they are following the sender and also have granted the sender a permission level equal to or greater than a selectable threshold. In addition to any other configurable options, the first member may be able to define a black list, which may comprise a list of contacts and/or members/non-members and/or supported unique identifiers. If the sender matches an entry on the black list the first member will not receive a notice, overriding other notification preferences that may be configured except possibly a white list. In addition to any other configurable options, the first member may be able to define a white list, which may comprise a list of contacts and/or member/non-member and/or supported unique identifiers. If the sender matches an entry on the white list the first member will receive a notice, overriding other notification preferences that may be configured except possibly a black list. It is possible that a sender might match entries on both a black list and a white list, in which case the system may be configured to allow the black list to override the white list, or may be configured to allow the white list to override the black list, or may be configured to resolve the conflict in another manner.

In some embodiments, the system may be able to provide notices to a first member when a second member makes a change to their profile that is visible to the first member according to the first member's permission level to view the second member's profile. Similarly, the system may be able to provide notices to a first member when a second member makes a change to their privacy or permission levels which results in new information becoming visible to the first member. Notices may be specific to a particular aspect or portion of profiles—for example there may be separate notices for status or general messages 212. As another example, a profile may include a blog, and there may be separate notices for changes or updates to blogs. The first member may be able to configure notification preferences to never receive notices for that change type. The first member may be able to configure notification preferences to always receive notices for that change type. The first member may be able to configure notification preferences to receive a notice only if they are following the second member. The first member may be able to configure notification preferences to receive a notice only if they have granted the second member a permission level equal to or greater than a selectable threshold. The first member may be able to configure notification preferences to receive a notice only if they are following the second member and also have granted the second member a permission level equal to or greater than a selectable threshold. In addition to any other configurable options, the first member may be able to define a black list, which may comprise a list of contacts and/or member/non-member and/or supported unique identifiers. If the second member matches an entry on the black list the first member will not receive a notice, overriding other notification preferences that may be configured except possibly a white list. In addition to any other configurable options, the first member may be able to define a white list, which may comprise a list of contacts and/or member/non-member and/or supported unique identifiers. If the second member matches an entry on the white list the first member will receive a notice, overriding other notification preferences that may be configured except possibly a black list. It is possible that a second member might match entries on both a black list and a white list, in which case the system may be configured to allow the black list to override the white list, or may be configured to allow the white list to override the black list, or may be configured to resolve the conflict in another manner.

### Profile Tethering

The disclosed privacy and permission system may allow the assignment of multiple administrators for managing a specific profile, each one able to have different administrative privileges. The administrator relationships may be revocable and/or non-revocable.

One type of non-revocable administrator relationship may be referred to as a “tether”. A situation where a tether may be implemented is between a first parent member, and a second child member. In one example, the system only permits tethers for child members below a predetermined age. In this case, the second child's profile 200 may be tethered to the first parent's profile. Once the second child member reaches a predetermined age, the tether may be removable or may be automatically removed by the system.

Parental tethering introduces a framework through which, for example, a parent or legal guardian may be allowed to limit, monitor, and if necessary intervene in the activities of their children on the social network 100. Such parental tethering improves safety for particularly young members and is expected to be most useful when parents proactively set up the accounts for themselves and their children. Parental tethering may also be useful in the verification of parental consent for young members of the social network 100. A profile for a first parent member may have to satisfy an identity verification by the system. In one example, the first parent member may need to have a paid subscription in place, where the financial transaction for the subscription provides a measure of identity verification. Certain specific verification protocols may be required to satisfy legal requirements in some countries, for example COPPA regulations in the United States.

In certain embodiments a first parent member may be able to set restrictions on the privacy levels and/or contact permissions and/or permission levels of the second child member. For example, the first parent member may be able to set a preference to lock the privacy levels of the second child member in such a way that the first parent member is able to adjust those privacy levels but the second child member is not able to adjust them. As another example, the first parent member may be able to limit who can contact the second child member by setting a preference that prevents the second child member from granting new contact permissions and/or new permission levels above a selected threshold. The first parent member may be able to configure a white list of contacts and/or members/non-members and/or supported unique identifiers such that only those in the list may be granted contact permission to contact the second child member. The first parent member may be able to configure a black list of contacts and/or members and/or supported unique identifiers such that those in the list may not be granted contact permission to contact the second child member. The first parent member may be able to configure notifications so as to receive notices of certain types of activity by the second child member. For example, the first parent member may be able to configure their preferences to receive notices whenever the second child member contacts or is contacted by an individual or entity for the first time, whenever the second child member grants a permission level above a certain threshold to an individual or entity or group, or whenever the second child member is active with their account outside of particular defined time frames.

In certain embodiments a first parent member may be able to set some or all of the same notifications generally available to members/non-members, as described above, for the second child member's account with those notifications delivered to the first parent member. These tether notifications are in addition to any notifications the second child member may set for the second child member's own account. In certain embodiments a first parent member may view reports regarding the status and/or history of a second child member tethered to his or her account. For example, the first parent member may be able to view a report detailing recent activities and activity times for the second child member, whose account is tethered to the first parent member's account on the social network 100.

It is contemplated that any part of any aspect or embodiment discussed in this specification can be implemented or combined with any part of any other aspect or embodiment discussed in this specification.

For the sake of convenience, the exemplary embodiments above are described as various interconnected functional blocks. This is not necessary, however, and there may be cases where these functional blocks are equivalently aggregated into a single logic device, program or operation with unclear boundaries. In any event, the functional blocks can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible. The scope of the claims should not be limited by the preferred embodiments set forth in the examples, but should be given the broadest interpretation consistent with the description as a whole.

1. A method for assigning a direct permission level governing access to a first member's profile information on a social network, the method comprising:
(a) determining whether a communication has been sent from the first member to a recipient; and
(b) assigning the direct permission level to the recipient,
wherein the profile information comprises a plurality of information types each associated with a privacy level, and a particular information type is accessible by the recipient if the assigned direct permission level satisfies the privacy level of the particular information type.

2. The method of claim 1 wherein the assigned direct permission level satisfies the privacy level of the particular information type if the assigned direct permission level is equal to or greater than the privacy level of the particular information type.

3. The method of claim 1 further comprising:
(a) determining the direct permission level; and
(b) assigning the determined direct permission level to the recipient.

4. The method of claim 3 wherein the direct permission level is determined from the communication.

5. The method of claim 3 wherein the direct permission level is determined according to a metarule.

6. The method of claim 5 wherein the metarule is a function of data comprising any one or more of the first member's profile information, the first member's privacy levels, the recipient's profile information, and permissions assigned to the recipient.

7. A method for granting contact permission to a recipient for contacting a first member through a social network, wherein the recipient is initially prevented from contacting the first member, the method comprising:
(a) determining whether the first member has sent a communication to the recipient; and
(b) when the first member has sent the communication to the recipient, granting the contact permission to the recipient to permit the recipient to contact the first member through the social network.

8. A method for granting contact permission to a recipient for contacting a first member through a social network, wherein the recipient is initially prevented from contacting the first member, and the first member has profile information on the social network comprising a plurality of information types, the method comprising:
(a) accessing a communication from the recipient to the first member;
(b) determining an information type from the communication;
(c) comparing the information type from the communication to at least one information type from the first member's profile information; and
(d) if the information type from the communication substantially matches at least one information type from the first member's profile information, granting the contact permission to the recipient.

9. A method for viewing a first member's profile information on a social network, the profile information comprising a plurality of information types each associated with a privacy level, the method comprising:
(a) receiving a proposed permission level from the first member;
(b) for each of the information types, comparing the privacy level for the information type to the proposed permission level; and
(c) displaying to the first member the information types with privacy levels satisfied by the proposed permission level.

10. The method of claim 10 wherein the privacy levels of the information types are satisfied when the proposed permission level is equal to or greater than the privacy levels of the information types.

11. The method of claim 10 wherein the information types are displayed to the first member as a profile page.

12. The method of claim 10 wherein the proposed permission level is received from a control region displayed on a graphical user interface presented to the first member.

13. A method for reserving a profile for a non-member of a social network, the method comprising:
(a) accessing a communication from a first member to the non-member;
(b) determining a unique identifier for the non-member from the communication; and
(c) reserving the profile for the non-member using the determined unique identifier.

14. The method of claim 13 wherein the unique identifier is an email address or a phone number.

15. The method of claim 13 further comprising granting contact permission to the non-member for contacting the first member through the social network.

16. The method of claim 13 further comprising assigning a direct permission level to the non-member for accessing the first member's profile information.

17. A permission and privacy system comprising:
(a) a processor; and
(b) a memory communicatively coupled to the processor, the memory having encoded thereon statements and instructions to configure the system to carry out the method as claimed in claim 1.

18. A computer readable medium having encoded thereon statements and instructions to configure a computer implemented system to carry out the method as claimed in claim 1.

19. A communication system comprising:
(a) a plurality of electronic devices;
(b) a server in data communication with the plurality of electronic devices, the server having at least one processor, the processor being configured to govern access to a first member's profile information on a social network, wherein the profile information comprises a plurality of information types each associated with a privacy level, and a particular information type is accessible by a recipient if a permission level assigned to the recipient satisfies the privacy level of the particular information type; and wherein the recipient may inherit a group permission assigned to a group by the first member based on the recipient's membership in the group; wherein the processor is configured to provide:
(i) one or more inheritance permitting direct permission levels assignable to the recipient by the first member which allow the recipient to inherit group permissions assigned to groups by the first member; and
(ii) one or more inheritance preventing direct permission levels assignable to the recipient by the first member which do not allow the recipient to inherit group permissions assigned to groups by the first member.

20. The communication system of claim 19, wherein an assignable inheritance permitting direct permission level and an assignable inheritance preventing direct permission level each provide equivalent non-inherited permissions.

21. The communication system of claim 19, wherein an assignable inheritance permitting direct permission level and an assignable inheritance preventing direct permission level each limit non-inherited permissions to a degree that is publicly viewable.

22. The communication system of claim 19, wherein an assignable inheritance permitting direct permission level is a default permission level.

23. The communication system of claim 19, wherein an assignable inheritance permitting direct permission level which limits permissions to a degree that is publicly viewable is a default permission level.
